(19) United States
(12) Patent Application Publication
(10) Pub. No.: US 2026/0058059 A1
(43) Pub. Date: Feb. 26, 2026

(54) CAPACITOR

(71) Applicant: Panasonic Intellectual Property Management Co., Ltd., Osaka (JP)

(72) Inventors: Yosuke HAGIHARA, Osaka (JP); Kazushi YOSHIDA, Osaka (JP); Tomohiro FUJITA, Osaka (JP)

(73) Assignee: Panasonic Intellectual Property Management Co., Ltd., Osaka (JP)

(21) Appl. No.: 19/115,881

(22) PCT Filed: Nov. 21, 2023
(86) PCT No.: PCT/JP2023/041784

§ 371 Date: Mar. 27, 2025

(30) Foreign Application Priority Data
Nov. 29, 2022 (JP) 2022-190471

(51) Int. Cl. H01G 4/01

(52) U.S. Cl. CPC H01G 4/01

(57) ABSTRACT

A silicon substrate has a second region, a third region, and an eave part which protrudes inward from the third region and overlaps with a second porous part when viewed in plan. The eave part satisfies at least one of a first condition or a second condition. The first condition is a condition that a first distance that is the shortest distance between a plane including a principal surface in the third region and a first porous part as measured in a thickness direction defined with respect to the silicon substrate should be longer than a second distance between the plane and a surface facing the second porous part, of the eave part as measured in the thickness direction. The second condition is a condition that a tip of the eave part should be located outside of an inner peripheral edge of the second region when viewed in plan.

### TECHNICAL FIELD

The present disclosure generally relates to capacitors and more specifically relates to a capacitor including a silicon substrate.

### BACKGROUND ART

Patent Literature 1 discloses a capacitor including a silicon substrate, a conductor layer, and a dielectric layer. The silicon substrate has a first principal surface and a second principal surface. The first principal surface of the silicon substrate has a capacity exhibiting region and a non-capacity exhibiting region. The silicon substrate has a porous part formed in a thickness direction in the capacity exhibiting region of the first principal surface. The porous part has a plurality of micropores.

Capacitors are sometimes required to increase their capacitance.

### CITATION LIST

### Patent Literature

Patent Literature 1: WO 2020/184517 A1

### SUMMARY OF INVENTION

An object of the present disclosure is to provide a capacitor that may have increased capacitance.

A capacitor according to an aspect of the present disclosure includes a silicon substrate, a dielectric layer, and a conductor layer. The silicon substrate has: a first region in which a first porous part is formed; a second region in which a second porous part is formed and which surrounds the first region; a third region which surrounds the second region; and an eave part which protrudes inward from the third region and overlaps with the second porous part when viewed in a plan. The dielectric layer is arranged to cover, in the silicon substrate, a surface of the first porous part, a surface of the second porous part, a surface of the eave part, and a principal surface in the third region. The conductor layer is stacked on the dielectric layer. The first porous part has a plurality of first micropores running in a thickness direction defined with respect to the silicon substrate. In the first porous part, each pair of first micropores located adjacent to each other which belong to the plurality of first micropores has a non-uniform interval in the thickness direction defined with respect to the silicon substrate. The second porous part has a plurality of second micropores. An interval between each of the plurality of second micropores and the eave part as measured in the thickness direction defined with respect to the silicon substrate increases its length as a distance from the first region increases and a distance to the third region decreases. The capacitor meets, with respect to the eave part, at least one of a first condition or a second condition. The first condition is a condition that a first distance that is the shortest distance between a plane including a principal surface in the third region and the first porous part as measured in the thickness direction defined with respect to the silicon substrate should be longer than a second distance between the plane and a surface, facing the second porous part, of the eave part as measured in the thickness direction defined with respect to the silicon substrate. The second condition is a condition that a tip of the eave part should be located outside of an inner peripheral edge of the second region when viewed in plan.

### BRIEF DESCRIPTION OF DRAWINGS

FIG. 1 is a schematic cross-sectional view of a capacitor according to a first embodiment;

FIG. 2 is a cross-sectional view illustrating, on a larger scale, a main part of the capacitor;

FIG. 3 is a plan view of the capacitor;

FIGS. 4A and 4B are cross-sectional views illustrating respective process steps of a method for manufacturing the capacitor;

FIGS. 5A and 5B are cross-sectional views illustrating respective process steps of the method for manufacturing the capacitor;

FIGS. 6A and 6B are cross-sectional views illustrating respective process steps of the method for manufacturing the capacitor;

FIG. 7 is a plan view illustrating a method for manufacturing the capacitor; and

FIG. 8 is a cross-sectional view illustrating, on a larger scale, a main part of a capacitor according to a second embodiment;

### DESCRIPTION OF EMBODIMENTS

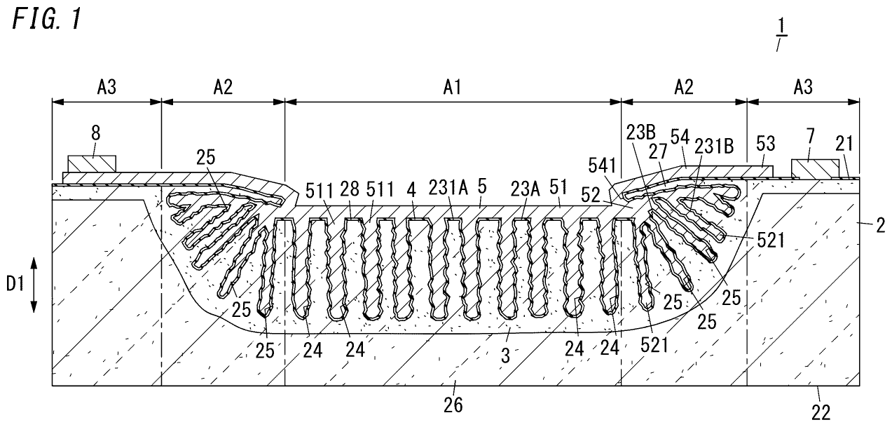

FIGS. 1 to 8 to be referred to in the following description of first and second embodiments and their variations are all schematic representations. Thus, the ratio of the dimensions (including thicknesses) of respective constituent elements illustrated on the drawings does not always reflect their actual dimensional ratio.

### First Embodiment

### (1) Overview

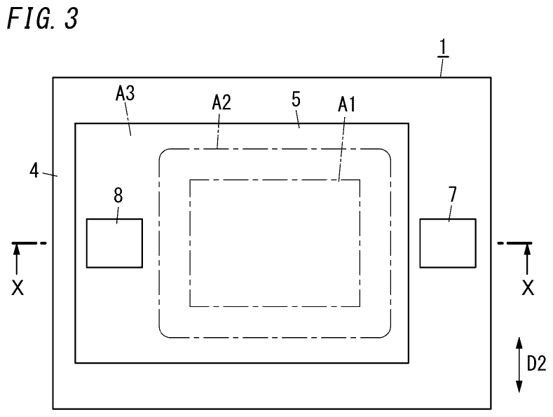

A capacitor 1 according to a first embodiment will be described with reference to FIGS. 1 to 3. Note that FIG. 1 is a cross-sectional view taken along the plane X-X in FIG. 3.

The capacitor 1 includes a silicon substrate 2, a dielectric layer 4, and a conductor layer 5. The silicon substrate 2 has a first region A1 in which a first porous part 23A is formed, a second region A2 in which a second porous part 23B is formed and which surrounds the first region A1, a third region A3 which surrounds the second region A2, and an eave part 27 which protrudes inward from the third region A3 and overlaps with the second porous part 23B when viewed in plan. The dielectric layer 4 is arranged to cover, in the silicon substrate 2, a surface 231A of the first porous part 23A, a surface 231B of the second porous part 23B, a surface 270 of the eave part 27, and a principal surface 21 in the third region A3. The conductor layer 5 is stacked on the dielectric layer 4.

The silicon substrate 2 also has a doped layer 3 containing a p-type dopant such as boron or indium.

In the capacitor 1, the doped layer 3 serves as a first electrode of the capacitor 1, and the conductor layer 5 serves as a second electrode of the capacitor 1. Thus, in the capacitor 1, the dielectric layer 4 is interposed between the first electrode and the second electrode.

The capacitor 1 further includes a first external connection electrode 7 and a second external connection electrode 8. The first external connection electrode 7 is connected to the doped layer 3. The second external connection electrode 8 is connected to the conductor layer 5.

### (2) Components of Capacitor

Respective components of the capacitor 1 will be described in further detail.

### (2.1) Silicon Substrate

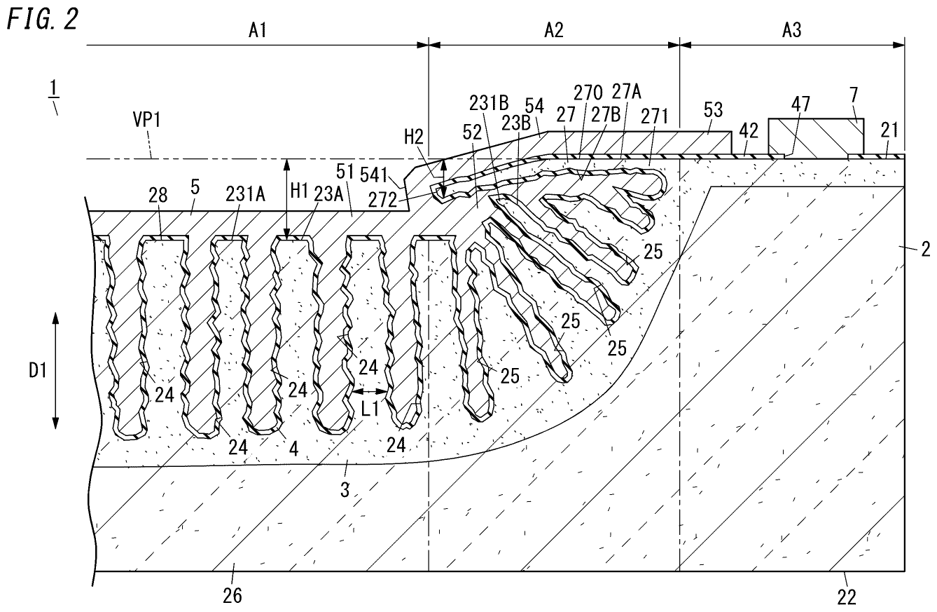

As shown in FIGS. 1 and 2, the silicon substrate 2 has the principal surface 21 (hereinafter also referred to as a “first principal surface 21”) and a second principal surface 22 opposite from the first principal surface 21. When viewed in plan in a thickness direction D1 defined with respect to the silicon substrate 2, the silicon substrate 2 has an outer edge having a rectangular shape. The silicon substrate 2 has a thickness equal to or greater than 300 μm and equal to or less than 1 mm, for example.

The silicon substrate 2 has a first region A1, a second region A2, a third region A3, and an eave part 27. In the first region A1, a first porous part 23A is formed. The second region A2 has a second porous part 23B and surrounds the first region A1. The third region A3 surrounds the second region A2. The eave part 27 protrudes inward from the third region A3 and overlaps with the second porous part 23B when viewed in plan. When viewed in plan in the thickness direction D1 defined with respect to the silicon substrate 2, the first region A1 is a rectangular region and is surrounded by the second region A2. When viewed in the thickness direction D1 defined with respect to the silicon substrate 2, the first region A1 does not have to be a rectangular region but may also be, for example, a circular region, a polygonal region other than the rectangular shape, or a region in the shape of a polygon other than convex polygons.

The first porous part 23A has a plurality of first micropores 24 running along the thickness direction D1 defined with respect to the silicon substrate 2. In the first porous part 23A, an interval L1 (refer to FIG. 2) between two adjacent ones (24) of the plurality of first micropores 24 is non-uniform in the thickness direction D1 defined with respect to the silicon substrate 2.

The plurality of first micropores 24 is formed through a third principal surface 28 located closer to the second principal surface 22 by a predetermined depth than a plane VP1 (refer to FIG. 2) that includes the first principal surface 21 of the silicon substrate 2. Each of the plurality of first micropores 24 is a pore, of which the depth as measured from the third principal surface 28 of the silicon substrate 2 in the thickness direction D1 defined with respect to the silicon substrate 2 is greater than the width of its opening through the third principal surface 28 of the silicon substrate 2. Each of the plurality of first micropores 24 runs in the thickness direction D1 defined with respect to the silicon substrate 2 from the third principal surface 28 of the silicon substrate 2 but does not reach the second principal surface 22 of the silicon substrate 2. In other words, the plurality of first micropores 24 do not penetrate through the silicon substrate 2 in the thickness direction D1 defined with respect to the silicon substrate 2. That is, the plurality of first micropores 24 is out of contact with the second principal surface 22 of the silicon substrate 2. The plurality of first micropores 24 each have an opening width equal to or greater than 0.1 μm and equal to or less than 10 μm, for example, at the third principal surface 28 of the silicon substrate 2. Moreover, the plurality of first micropores 24 each have a depth smaller than the thickness of the silicon substrate 2. The depths of the plurality of first micropores 24 as measured in the thickness direction D1 defined with respect to the silicon substrate 2 are, for example, equal to or greater than 20 μm and equal to or less than 300 μm, more preferably equal to or greater than 30 μm and equal to or less than 100 μm. Note that an upper limit value of the depths of the plurality of first micropores 24 may be determined appropriately by, for example, the opening widths of the plurality of first micropores 24 and respective methods of forming the doped layer 3, the dielectric layer 4, and the conductor layer 5. The opening widths and the depths of the first micropores 24 in the first porous part 23A of the silicon substrate 2 are values determined based on, for example, a cross-sectional scanning electron microscope (SEM) image of the capacitor 1.

A surface 231A of the first porous part 23A is made up of respective inner surfaces of the plurality of first micropores 24 that are formed through the third principal surface 28 of the silicon substrate 2 and the third principal surface 28 of the silicon substrate 2.

In the capacitor 1, the deeper the plurality of first micropores 24 of the first porous part 23A are, the more significantly the surface area of the surface 231A of the first porous part 23A, and therefore, the capacitance of the capacitor 1, may be increased accordingly. Also, in the capacitor 1, the larger the number of the first micropores 24 in the first porous part 23A is, the more significantly the surface area of the surface 231A of the first porous part 23A, and therefore, the capacitance of the capacitor 1, may be increased accordingly.

In the capacitor 1, an interval L1 between two adjacent ones (24) of the plurality of first micropores 24 is non-uniform in the thickness direction D1 defined with respect to the silicon substrate 2 as shown in FIG. 2. In the capacitor 1, the surface area of the surface 231A of the first porous part 23A may be increased compared to a situation where the interval L1 between two adjacent ones (24) of the plurality of first micropores 24 is uniform in the thickness direction D1 defined with respect to the silicon substrate 2. Note that the interval L1 between two adjacent ones (24) of the plurality of first micropores 24 is uniform in the thickness direction D1 defined with respect to the silicon substrate 2 when the plurality of first micropores 24 are formed by, for example, dry etching. Moreover, in the capacitor 1, each of the plurality of first micropores 24 has a non-uniform opening width in the thickness direction D1 defined with respect to the silicon substrate 2.

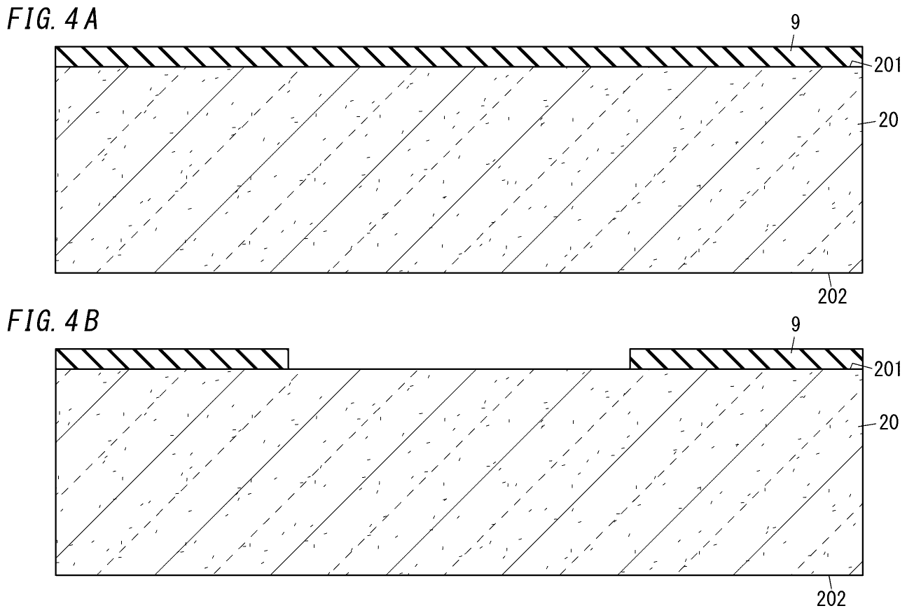

In a cross section as viewed in a second direction D2 (refer to FIG. 3) perpendicular to the thickness direction D1 (hereinafter also referred to as a “first direction D1”) defined with respect to the silicon substrate 2, neither the inner side surface of one of two adjacent first micropores 24 nor the inner side surface of the other one of the two adjacent first micropores 24 has a straight-line shape but each of these inner side surfaces has a profile with concave and convex parts. The difference in height between a trough and a crest of the concave and convex parts is smaller than the opening widths of the first micropores 24. The difference in height between the trough and the crest of the concave and convex parts is a value determined based on, for example, a cross-sectional SEM image of the capacitor 1. The difference in height between the trough and the crest of the concave and convex parts may be changed depending on, for example, the impurity concentration of ap-type silicon wafer 20 (refer to FIG. 4A), from which the silicon substrate 2 is cut out, and the condition of anodization.

The second porous part 23B has a plurality of second micropores 25. An interval between each of the plurality of the second micropores 25 and the eave part 27 as measured in the thickness direction D1 defined with respect to the silicon substrate 2 increases its length as the distance from the first region A1 increases (i.e., the distance to the third region A3 decreases). In other words, the plurality of second micropores are formed in a diagonal direction tilted with respect to the thickness direction D1 defined with respect to the silicon substrate 2.

In a cross section as viewed in the second direction D2 (refer to FIG. 3), neither the inner side surface of one of two adjacent second micropores 25 nor the inner side surface of the other one of the two adjacent second micropores 25 has a straight-line shape but each of these inner side surfaces has a profile with concave and convex parts. The difference in height between a trough and a crest of the concave and convex parts is smaller than the opening widths of the second micropores 25. The difference in height between the trough and the crest of the concave and convex parts is a value determined based on, for example, a cross-sectional SEM image of the capacitor 1. The difference in height between the trough and the crest of the concave and convex parts may be changed depending on, for example, the impurity concentration of the p-type silicon wafer 20 (refer to FIG. 4A), from which the silicon substrate 2 is cut out, and the condition of anodization.

The silicon substrate 2 has a porous region including the first porous part 23A and the second porous part 23B. The porous region decreases its width as the distance from the third principal surface 28 increases (i.e., the distance to the second principal surface 22 decreases) in the thickness direction D1 defined with respect to the silicon substrate 2.

The eave part 27 protrudes inward from the third region A3 and overlaps with the second porous part 23B when viewed in plan. As shown in FIG. 2, the surface 270 of the eave part 27 includes a surface 27B (hereinafter also referred to as a “lower surface 27B”) facing the second porous part 23B and an upper surface 27A opposite from the lower surface 27B. The eave part 27 has a proximal end 271 connected to the third region A3 and a tip 272 adjacent to the first region A1. At the proximal end 271 of the eave part 27, the upper surface 27A of the eave part 27 is located on the same plane as the first principal surface 21 of the silicon substrate 2. In other words, the upper surface 27A of the eave part 27 is located on the plane VP1.

The capacitor 1 meets both a first condition and a second condition with respect to the eave part 27.

The first condition is a condition that a first distance H1 should be longer than a second distance H2. The first distance H1 is the shortest distance between the plane VP1 that includes the first principal surface 21 in the third region A3 and the first porous part 23A. The second distance H2 is the distance between the plane VP1 and the surface 27B, facing the second porous part 23B, of the eave part 27.

The second condition is a condition that the tip 272 of the eave part 27 is located outside of the inner peripheral edge of the second region A2 when viewed in plan.

The capacitor 1 has a body region 26 located between the doped layer 3 and the second principal surface 22 of the silicon substrate 2 and having as high an impurity concentration as the p-type silicon wafer 20. Moreover, the body region 26 of the silicon substrate 2 has as high a carrier concentration as the p-type silicon wafer 20.

If the silicon substrate 2 is cut out of the p-type silicon wafer 20 (refer to FIG. 4A), the body region 26 of the silicon substrate 2 contains, for example, boron (B) as a dopant, but this should not be construed as limiting. Alternatively, the body region 26 may contain indium (In) as a dopant. The impurity concentration of the body region 26 in the silicon substrate 2 is, for example, equal to or higher than 1×10¹³ cm⁻³ and equal to or lower than 1×10¹⁷ cm⁻³, more preferably equal to or higher than 5×10¹³ cm⁻³ and equal to or lower than 5×10¹⁶ cm⁻³. The impurity concentration of the body region 26 in the silicon substrate 2 is a value determined by, for example, secondary ion mass spectroscopy (SIMS) analysis.

The doped layer 3 of the silicon substrate 2 is a diffusion layer. The conductivity type of the doped layer 3 is the same as the conductivity type of the body region 26 of the silicon substrate 2. Moreover, the impurity concentration of the doped layer 3 is higher than the impurity concentration of the body region 26 of the silicon substrate 2. Thus, if the conductivity type of the body region 26 of the silicon substrate 2 is p-type, the doped layer 3 is a p-type silicon region (a p⁺ silicon region) having a higher concentration than the body region 26 of the silicon substrate 2. The dopant in the doped layer 3 may be, for example, of the same type as the dopant in the body region 26 of the silicon substrate 2. More specifically, if the dopant introduced into the body region 26 is boron, the dopant in the doped layer 3 is boron. The impurity concentration of the doped layer 3 is equal to or higher than 1×10¹⁸ cm⁻³ and equal to or lower than 1×10²¹ cm⁻³, more preferably equal to or higher than 5×10¹⁸ cm⁻³ and equal to or lower than 1×10²⁰ cm⁻³. The impurity concentration of the doped layer 3 is a value determined by, for example, SIMS analysis.

Moreover, the carrier concentration of the doped layer 3 is higher than the carrier concentration of the body region 26. The carrier concentration of the doped layer 3 and the carrier concentration of the body region 26 are values determined by, for example, carrier concentration profile observation through a scanning microwave impedance microscope (sMIM).

When the respective carrier concentration levels of the doped layer 3 and the body region 26 are discussed to determine which level is higher than the other, the carrier concentrations are not limited to the values determined by the carrier concentration profile observation by the sMIM. Alternatively, the carrier concentration of the doped layer 3 and the carrier concentration of the body region 26 may be values determined by, for example, carrier concentration profile observation by scanning capacitance microscopy (SCM). Still alternatively, the carrier concentration of the doped layer 3 and the carrier concentration of the body region 26 may be values determined by, for example, carrier concentration profile observation by scanning nonlinear dielectric microscopy (SNDM).

The thickness of the doped layer 3 is preferably equal to or greater than 10 nm and equal to or less than 10,000 nm, more preferably equal to or greater than 50 nm and equal to or less than 5,000 nm. The thickness of the doped layer 3 is a value determined by, for example, observing a cross section of the capacitor 1 through an sMIM.

The doped layer 3 is formed in the silicon substrate 2 along the first principal surface 21 of the silicon substrate 2, the surface 231A of the first porous part 23A, the surface 231B in the second porous part 23B, the surface 270 of the eave part 27, and the first principal surface 21 of the silicon substrate 2 in the third region A3 of the silicon substrate 2.

### (2.2) Dielectric Layer

The dielectric layer 4 is arranged to cover the surface 231A of the first porous part 23A, the surface 231B of the second porous part 23B, the surface 270 of the eave part 27, and the first principal surface 21 in the third region A3 in the silicon substrate 2. More specifically, the dielectric layer 4 is formed on the doped layer 3 and has a shape conforming to those of the surface 231A of the first porous part 23A, the surface 231B of the second porous part 23B, the surface 270 of the eave part 27, and the first principal surface 21 in the third region A3 of the silicon substrate 2. The dielectric layer 4 has portions interposed between the doped layer 3 and the conductor layer 5 in the thickness direction D1 defined with respect to the silicon substrate 2, portions interposed between the doped layer 3 and the conductor layer 5 inside the plurality of first micropores 24 of the first porous part 23A, and portions interposed between the doped layer 3 and the conductor layer 5 inside the plurality of second micropores 25 of the second porous part 23B.

The dielectric layer 4 has a thickness equal to or greater than 10 nm and equal to or less than 500 nm, for example. An upper limit of the thickness of the dielectric layer 4 is restricted by, for example, the opening widths of the first micropores 24 in the first porous part 23A in one direction aligned with the first principal surface 21 of the silicon substrate 2, the thickness, as measured in the one direction, of the conductor layer 5 inside the first micropores 24 in the first porous part 23A, and the opening widths of the second micropores 25 in the second porous part 23B.

The dielectric layer 4 has a multilayer structure including a plurality of dielectric films stacked one on top of another, but this should not be construed as limiting. The dielectric layer 4 may also be a single dielectric film. If the dielectric layer 4 has the multilayer structure, the dielectric layer 4 includes, for example: a first dielectric film (e.g., a first silicon oxide film) on the doped layer 3; a second dielectric film (e.g., a silicon nitride film) on the first dielectric film; and a third dielectric film (e.g., a second silicon oxide film) on the second dielectric film. A material for the first silicon oxide film and the second silicon oxide film may be, for example, silicon dioxide (SiO₂). The composition of the first silicon oxide film and the second silicon oxide film does not have to be SiO₂ in a strict sense. Optionally, the composition of the first silicon oxide film may be different from the composition of the second silicon oxide film. If the dielectric layer 4 is configured as a single dielectric film, a material for the dielectric film may be, for example, silicon oxide. The material for the dielectric film is not limited to the silicon oxide but may also be, for example, titanium oxide, zirconium oxide, hafnium oxide, vanadium oxide, tungsten oxide, niobium oxide, tantalum oxide, or aluminum oxide.

### (2.3) Conductor Layer

As shown in FIG. 1, the conductor layer 5 is stacked on the dielectric layer 4. The conductor layer 5 is formed on the dielectric layer 4. The conductor layer 5 overlaps with the first region A1, the second region A2, the third region A3, and the eave part 27 of the silicon substrate 2 when viewed in plan in the thickness direction D1 defined with respect to the silicon substrate 2.

The conductor layer 5 may be, for example, a conductive polycrystalline silicon layer. The impurity concentration of the conductive polycrystalline silicon layer is, for example, equal to or higher than 1×10¹⁸ cm⁻³ and equal to or lower than 1×10²¹ cm⁻³, more preferably equal to or higher than 5×10¹⁸ cm⁻³ and equal to or lower than 1×10²⁰ cm⁻³. The dopant introduced into the conductive polycrystalline silicon layer includes one selected from the group consisting of, for example, boron, indium, phosphorus, arsenic, and antimony. The conductor layer 5 is not limited to the conductive polycrystalline silicon layer but may be, for example, a metal electrode layer. A material for the metal electrode layer includes at least one selected from the group consisting of, for example, ruthenium (Ru), titanium (Ti), tantalum (Ta), tungsten (W), and aluminum (Al). More specifically, the material for the metal electrode layer may be, for example, ruthenium, titanium, tantalum, tungsten, aluminum, or an alloy including one of these metals as a main component.

The conductor layer 5 includes a first conducive part 51, a second conducive part 52, a third conducive part 53, and a fourth conducive part 54. The first conducive part 51 covers the surface 231A of the first porous part 23A. Therefore, the first conducive part 51 includes a plurality of first columnar portions 511 that are located inside the plurality of first micropores 24 in the first porous part 23A. The second conducive part 52 covers the surface 231B of the second porous part 23B. Therefore, the second conducive part 52 includes a plurality of second columnar portions 521 that are located inside the plurality of second micropores 25 in the second porous part 23B. The third conducive part 53 covers the principal surface 21 in the third region A3. The fourth conducive part 54 covers the eave part 27. It is preferable that the fourth conducive part 54 be connected to at least one of the first conducive part 51 or the second conducive part 52 in at least at a part of an inner peripheral edge 541 of the fourth conducive part 54 in the conductor layer 5 in order to improve the electrical characteristics of the capacitor 1. More preferably, the fourth conducive part 54 is connected to at least one of the first conducive part 51 or the second conducive part 52 over the entire inner peripheral edge 541 of the fourth conducive part 54 in the conductor layer 5 in order to improve the electrical characteristics of the capacitor 1. In the conductor layer 5 of the capacitor 1 according to the first embodiment, the fourth conducive part 54 is connected to the first conducive part 51 and the second conducive part 52 over the entire inner peripheral edge 541 of the fourth conducive part 54.

### (2.4) First External Connection Electrode and Second External Connection Electrode

The first external connection electrode 7 is connected to the doped layer 3 of the silicon substrate 2 as shown in FIGS. 1 and 2. More specifically, the first external connection electrode 7 is connected to the first principal surface 21 of the silicon substrate 2, and to the doped layer 3, through a contact hole 47 (refer to FIG. 2) formed through a portion 42 (refer to FIG. 2) of the dielectric layer 4. The portion 42 is located in the third region A3 of the first principal surface 21 of the silicon substrate 2. In the capacitor 1, the first external connection electrode 7 is electrically connected to the doped layer 3 of the silicon substrate 2. As used herein, “the first external connection electrode 7 is electrically connected to the doped layer 3 of the silicon substrate 2” means that the first external connection electrode 7 is in ohmic contact with the doped layer 3 of the silicon substrate 2.

When viewed in plan in the thickness direction D1 defined with respect to the silicon substrate 2, the first external connection electrode 7 has an outer edge having, for example, a quadrangular shape (refer to FIG. 3), but this should not be construed as limiting. The outer edge may have, for example, a circular shape. The first external connection electrode 7 overlaps with a part of the third region A3 of the silicon substrate 2 but overlaps with neither the first region A1 nor the second region A2 of the silicon substrate 2 when viewed in plan in the thickness direction D1 defined with respect to the silicon substrate 2.

The second external connection electrode 8 is connected to the conductor layer 5. In the capacitor 1, the second external connection electrode 8 is electrically connected to the conductor layer 5. As used herein, “the second external connection electrode 8 is electrically connected to the conductor layer 5” means that the second external connection electrode 8 is in ohmic contact with the conductor layer 5. The second external connection electrode 8 overlaps with a part of the third region A3 of the silicon substrate 2 but overlaps with neither the first region A1 nor the second region A2 of the silicon substrate 2 when viewed in plan in the thickness direction D1 defined with respect to the silicon substrate 2.

Examples of materials for the first external connection electrode 7 and the second external connection electrode 8 include, without limitation, aluminum but may also include gold, platinum, and ruthenium. The material for the second external connection electrode 8 may be the same as the material for the first external connection electrode 7, but this should not be construed as limiting. The material for the second external connection electrode 8 may also be different from the material for the first external connection electrode 7.

The thickness of the first external connection electrode 7 and the second external connection electrode 8 is, for example, equal to or greater than 1 μm and equal to or less than 3 μm. The second external connection electrode 8 may be as thick as the first external connection electrode 7, but this should not be construed as limiting. The thickness of the second external connection electrode 8 may be different from the thickness of the first external connection electrode 7.

### (2) Method for Manufacturing Capacitor

A method for manufacturing the capacitor 1 includes, for example, a first step, a second step, a third step, a fourth step, a fifth step, a sixth step, a seventh step, and an eighth step. The method for manufacturing the capacitor 1 will be described with reference to FIGS. 4A, 4B, 5A, 5B, 6A, 6B, and 7.

The first step includes providing a p-type silicon wafer 20, from which the silicon substrate 2 is cut out, and then forming an insulating layer 9 (refer to FIG. 4A) on the first principal surface 201 of the p-type silicon wafer 20. The p-type silicon wafer 20 has a first principal surface 201 and a second principal surface 202 opposite from the first principal surface 201. The first principal surface 201 of the p-type silicon wafer 20 may be, for example, a (100) plane, but this should not be construed as limiting. The first principal surface 201 may also be, for example, a (110) plane or a (111) plane. The first principal surface 201 of the p-type silicon wafer 20 may be, for example, a crystallographic plane, of which an off-axis angle defined with respect to a (100) plane is greater than 0 degrees and equal to or less than 5 degrees. As used herein, the “off-axis angle” is a tilt angle defined by the first principal surface 201 with respect to a (100) plane. Thus, if the off-axis angle is 0 degrees, then the first principal surface 201 is a (100) plane. When the insulating layer 9 is formed, a silicon oxide layer is formed over the entire first principal surface 201 of the p-type silicon wafer 20 by, for example, thermal oxidation; and then a silicon nitride layer is formed on the silicon oxide layer by, for example, chemical vapor deposition (CVD).

The second step includes patterning the insulating layer 9 into a predetermined pattern by photolithography and etching techniques (refer to FIG. 4B). In this step, the first principal surface 201 of the p-type silicon wafer 20 corresponds to the first principal surface 21 of the silicon substrate 2. The insulating layer 9 in the predeterminate pattern covers, for example, regions, corresponding to the second region A2 and the third region A3 of the silicon substrate 2, of the first principal surface 201 of the p-type silicon wafer 20 but does not cover a region thereof corresponding to the first region A1.

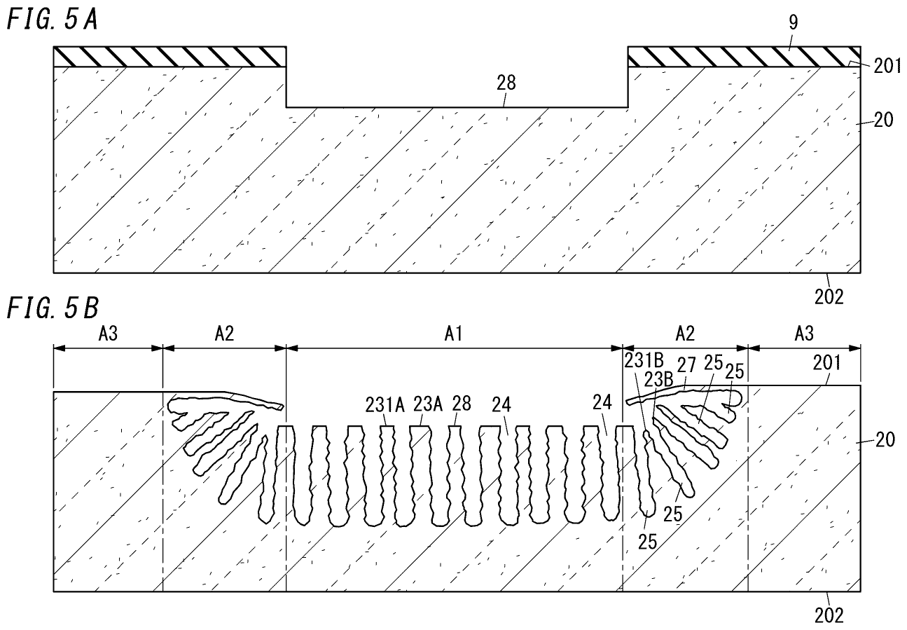

The third step includes etching, using the insulating layer 9 as an etch mask, the p-type silicon wafer 20 to a predetermined depth from the first principal surface 201 of the p-type silicon wafer 20 to form a recess and thereby defining the third principal surface 28 (refer to FIG. 5A) as an inner bottom surface of the recess. In the third step, dry etching is used for etching the p-type silicon substrate 20, but this should not be construed as limiting. Alternatively, wet etching may also be used.

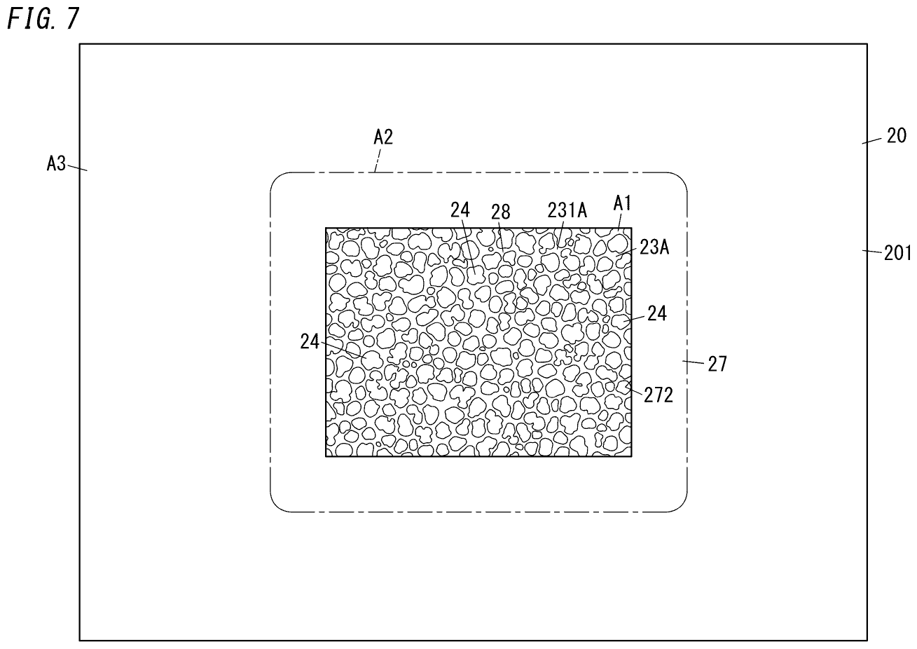

The fourth step includes anodizing the p-type silicon wafer 20 using the p-type silicon wafer 20 as an anode, thereby forming a p-type silicon wafer 20 (refer to FIGS. 5B and 7) having a first porous part 23A, a second porous part 23B, and an eave part 27 and then removing the insulating layer 9. In the anodization, a platinum electrode is arranged to face the third principal surface 28 of the p-type silicon wafer 20 and the insulating layer 9 in an electrolytic solution, and a current having a prescribed current density is allowed to flow for a predetermined amount of time with the p-type silicon wafer 20 used as an anode and the platinum electrode used as a cathode. As a result of the anodization, the p-type silicon wafer 20 is made porous, thus forming the first porous part 23A, the second porous part 23B, and the eave part 27. The electrolytic solution may be, for example, a mixture of hydrofluoric acid and ethanol. Note that before the anodization, an electrode to be used in the anodization is formed on the second principal surface 202 of the p-type silicon wafer 20. This electrode is removed after the anodization. The electrode may be, for example, a metal film.

In the fourth step, changing at least one of the concentration of hydrogen fluoride in the electrolytic solution, the prescribed current density, or the predetermined amount of time allows the shapes and the depths of the plurality of first micropores 24 and the shapes and the depths of the plurality of second micropores 25 to be controlled. The concentration of hydrogen fluoride in the electrolytic solution may be, for example, equal to or higher than 1 wt % and equal to or lower than 80 wt %, preferably equal to or higher than 20 wt % and equal to or lower than 40 wt %. Also, according to the method for manufacturing the capacitor 1, the shapes of the plurality of first micropores 24 and the plurality of second micropores 25 may also be changed by changing the resistivity of the p-type silicon wafer 20 determined by the impurity concentration of the p-type silicon wafer 20 from which the silicon substrate 2 is cut out.

Note that the third step and the fourth step may be conducted continuously when wet etching is used as an etch method in the third step.

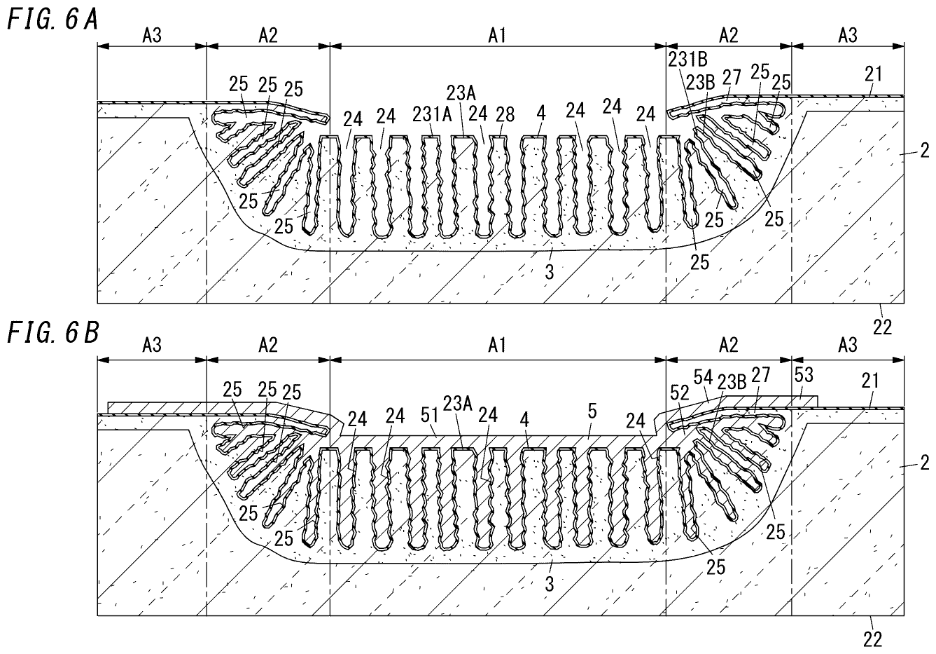

The fifth step includes forming the doped layer 3 out of the diffusion layer in the p-type silicon wafer 20 (refer to FIG. 6A). That is, the fifth step includes a diffusion step. The diffusion step includes thermally diffusing a p-type dopant (e.g., boron) into the p-type silicon wafer 20, thereby forming the doped layer 3. As a result, the silicon substrate 2 having the first porous part 23A, the second porous part 23B, the eave part 27, and the doped layer 3 is formed.

The sixth step includes forming a dielectric layer 4 on the doped layer 3 as shown in FIG. 6A. In the sixth step, a first silicon oxide film of the dielectric layer 4 is formed by, for example, CVD, a silicon nitride film of the dielectric layer 4 is formed by, for example, CVD, and a second silicon oxide film of the dielectric layer 4 is formed by, for example, CVD. Alternatively, the first silicon oxide film may also be formed by thermal oxidation.

The seventh step includes forming a conductor layer 5 on the dielectric layer 4 as shown in FIG. 6B. More specifically, the seventh step includes forming, first of all, on the dielectric layer 4, a conductor material layer as a prototype of the conductor layer 5. In the seventh step, the conductor material layer is formed by, for example, CVD, and then patterned by, for example, photolithographic and etching techniques, thereby forming the conductor layer 5 out of a part of the conductor material layer.

The eighth step includes forming a first external connection electrode 7 and a second external connection electrode 8 (refer to FIG. 1). More specifically, the eighth step includes forming, first of all, a contact hole 47 (refer to FIG. 2) through the dielectric layer 4, thereby exposing a part of the first principal surface 21 of the silicon substrate 2. In the eighth step, the contact hole 47 is formed by, for example, photolithographic and etching techniques. Thereafter, a thin film forming method, a photolithographic technique, and an etching technique, for example, are used in combination to form the first external connection electrode 7 and the second external connection electrode 8. The thin film forming method may be, for example, evaporation, sputtering, or CVD. The eighth step may include heat treatment for allowing the first external connection electrode 7 to make ohmic contact with the doped layer 3.

In the method for manufacturing the capacitor 1, a second wafer including a plurality of capacitors 1 may be obtained by providing a first wafer (for example, a silicon wafer) as the p-type silicon wafer 20 in the first step and thereafter performing the first step to the eighth step on the first wafer. In the method for manufacturing the capacitor 1, a plurality of capacitors 1 may be obtained by cutting off the second wafer with, for example, a dicing saw or a laser dicing device in the eighth step.

### (4) Advantages

In a capacitor 1 according to the first embodiment, a silicon substrate 2 has a first region Al in which a first porous part 23A is formed, a second region A2 in which a second porous part 23B is formed and which surrounds the first region A1, a third region A3 which surrounds the second region A2, and an eave part 27 which protrudes inward from the third region A3 and overlaps with the second porous part 23B when viewed in plan. Also, in the capacitor 1 according to the first embodiment, the dielectric layer 4 is arranged to cover a surface 231 A of the first porous part 23A, a surface 231B of the second porous part 23B, a surface 270 of the eave part 27, and a principal surface 21 in the third region A3 of the silicon substrate 2. The capacitor 1 meets both a first condition and a second condition with respect to the eave part 27. The first condition is the condition that a first distance H1 that is the shortest distance between a plane VP1 that includes the principal surface 21 in the third region A3 and the first porous part 23A in a thickness direction D1 defined with respect to the silicon substrate 2 should be longer than a second distance H2 that is the distance between the plane VP1 and a surface 27B, facing the second porous part 23B, of the eave part 27 in the thickness direction D1 defined with respect to the silicon substrate 2. The second condition is the condition that a tip 272 of the eave part 27 should be located outside of the inner peripheral edge of the second region A2 when viewed in plan. Therefore, the capacitance of the capacitor 1 according to the first embodiment may be increased accordingly. More specifically, in the capacitor 1 according to the first embodiment, the capacitance of the capacitor 1 may be increased with the size of a chip not increased, because the silicon substrate 2 includes not only the first porous part 23A but also the second porous part 23B and because the dielectric layer 4 and the conductor layer 5 are also formed inside the plurality of second micropores 25 in the second porous part 23B. Also, the capacitor 1 according to the first embodiment meets both the first condition and the second condition with respect to the eave part 27, thus reducing the chances that the openings of the plurality of second micropores 25 of the second porous part 23B are closed by the eave part 27 that would be bent during the manufacturing process. As a result, the capacitor 1 according to the first embodiment makes it easier to form, as designed, the dielectric layer 4 and the conductor layer 5 inside the plurality of second micropores 25 in the second porous part 23B, thus further increasing the capacitance of the capacitor 1.

It is preferable that the first distance H1 be equal to or greater than twice the thickness of the eave part 27 in order to reduce the chances that the openings of the plurality of second micropores 25 of the second porous part 23B are closed by the eave part 27. Also, it is preferable that the first distance H1 be equal to or less than ten times the thickness of the eave part 27 in order to reduce the degree of a decrease in capacitance.

Also, the conductor layer 5 of the capacitor 1 according to the first embodiment, the fourth conducive part 54 is connected to the first conducive part 51 and the second conducive part 52 in at least a part of the inner peripheral edge 541 of the fourth conducive part 54. As a result, the capacitor 1 according to the first embodiment may reduce the resistance of the conductor layer 5 more significantly and thereby improve the characteristics of the capacitor 1.

In the conductor layer 5 of the capacitor 1 according to the first embodiment, it is preferable that the fourth conducive part 54 be connected to the first conducive part 51 and the second conducive part 52 over the entire inner peripheral edge 541 of the fourth conducive part 54. Thus, the capacitor 1 according to the first embodiment may reduce a variation in pressure in the gap under the eave part 27, and thereby reduce the chances of doing damage to the eave part 27, in a step after the conductor layer 5 has been formed during the manufacturing process (e.g., during a vacuum process such as evaporation, sputtering, or CVD in the above-described eighth step).

Also, the capacitor 1 according to the first embodiment achieves the advantage that the surface area of the surface 231A of the first porous part 23A and the surface area of the surface 231B of the second porous part 23B are easily increased because the silicon substrate 2 includes the doped layer 3. More precisely, forming the first porous part 23A and the second porous part 23B by anodizing the p-type silicon wafer 20 that has a lower impurity concentration than the doped layer 3 before forming the doped layer 3 may increase the surface area of the surface 231A of the first porous part 23A and the surface area of the surface 231B of the second porous part 23B.

### Second Embodiment

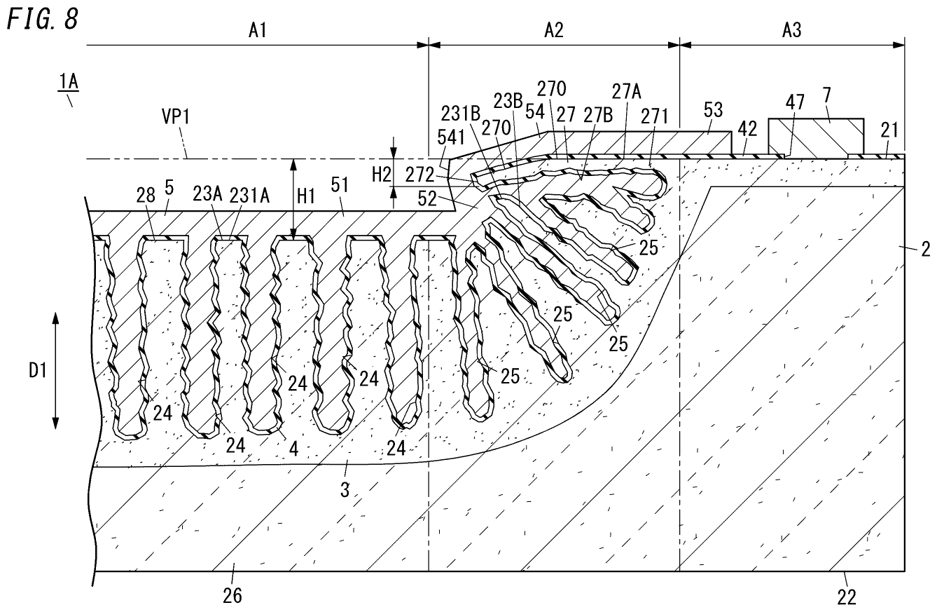

A capacitor 1A according to a second embodiment will be described with reference to FIG. 8. As for the capacitor 1A according to the second embodiment, any constituent element, having the same function as a counterpart of the capacitor 1 (refer to FIGS. 1 to 3) according to the first embodiment, will be designated by the same reference numeral as that counterpart's, and description thereof will be omitted as appropriate herein.

### (1) Configuration

In the capacitor 1A according to the second embodiment, its eave part 27 is shorter than the eave part 27 of the capacitor 1 according to the first embodiment and the distance between the inner peripheral edge of the second region A2 and a tip 272 of the eave part 27 is longer than in the capacitor 1 according to the first embodiment when viewed in plan. Thus, in the capacitor 1A according to the second embodiment, the plurality of second micropores 25 includes at least one second micropore 25 having an opening that does not overlap with the eave part 27 when viewed in plan.

### (2) Manufacturing Method

A method for manufacturing a capacitor 1A according to the second embodiment is substantially the same as the method for manufacturing a capacitor 1 according to the first embodiment. As for the method for manufacturing a capacitor 1A according to the second embodiment, description of the same process steps as those of the method for manufacturing a capacitor 1 according to the first embodiment will be omitted as appropriate herein.

The method for manufacturing the capacitor 1A according to the second embodiment includes a first step, a second step, a third step, a fourth step, a fifth step, a sixth step, a seventh step, and an eighth step as well as the method for manufacturing a capacitor 1 according to the first embodiment.

In the method for manufacturing the capacitor 1A according to the second embodiment, the eave part 27 is patterned to decrease its length after the anodization has been conducted in the fourth step, which is a difference from the method for manufacturing the capacitor 1 according to the first embodiment. For example, when the eave part 27 is patterned, photolithography and etching techniques may be used.

### Advantages

A capacitor 1A according to the second embodiment may improve the capability of forming the dielectric layer 4 and the conductor layer 5 inside the plurality of second micropores 25 in the second porous part 23B compared with the capacitor 1 according to the first embodiment.

### Variations

Note that the first and second embodiments and their variations described above are only exemplary ones of various embodiments of the present disclosure and their variations and should not be construed as limiting. Rather, the exemplary embodiments and their variations may be readily modified in various manners depending on a design choice or any other factor without departing from the scope of the present disclosure.

For example, the conductivity type of the body region 26 and the doped layer 3 of the silicon substrate 2 is not limited to p-type but may also be n-type. If the conductivity type of the body region 26 and the doped layer 3 of the silicon substrate 2 is n-type, the body region 26 and the doped layer 3 contain, for example, phosphorus (P) as an n-type dopant, but this should not be construed as limiting. Alternatively, the body region 26 and the doped layer 3 may contain arsenic (As) or antimony (Sb) as the dopant. Also, even in the case that the conductivity type of the body region 26 and the doped layer 3 of the silicon substrate 2 is n-type, the impurity concentration of the doped layer 3 is higher than that of the body region 26. Also, the carrier concentration of the doped layer 3 is higher than that of the body region 26.

In the case that the conductivity type of the doped layer 3 and the body region 26 is n-type, the method for manufacturing the capacitor 1 is substantially the same as the method for manufacturing the capacitor 1 according to the embodiment 1. In that case, however, the first step includes providing an n-type silicon wafer instead of the p-type silicon wafer 20. Also, in the anodization process, the number of holes inside the n-type silicon wafer is increased by irradiating the n-type silicon wafer, which will be cut off to form the silicon substrate 2, with light in order to form the first porous part 23A and the second porous part 23B.

Also, the capacitor 1 only needs to meet at least one of the first condition or the second condition with respect to the eave part 27. Therefore, in the capacitor 1, the tip 272 of the eave part 27 may, for example, overlap with, or be located inside of, the inner peripheral edge of the second region A2 when viewed in plan.

The silicon substrate 2 may be provided with a plurality of circuit components (such as MOSFETs) other than the capacitor 1, 1A. That is to say, the capacitor 1, 1A according to the present disclosure is appliable to a semiconductor device including the capacitor 1, 1A (such as an integrated circuit (IC) chip including the capacitor 1, 1A).

### Aspects The first and second embodiments and their variations described above are specific implementations of the following aspects of the present disclosure.

A capacitor (1; 1A) according to a first aspect includes a silicon substrate (2), a dielectric layer (4), and a conductor layer (5). The silicon substrate (2) has: a first region (A1) in which a first porous part (23A) is formed; a second region (A2) in which a second porous part (23B) is formed and which surrounds the first region (A1); a third region (A3) which surrounds the second region (A2); and an eave part (27) which protrudes inward from the third region (A3) and overlaps with the second porous part (23B) when viewed in plan. The dielectric layer (4) is arranged to cover, in the silicon substrate (2), a surface (231A) of the first porous part (23A), a surface (231B) of the second porous part (23B), a surface (270) of the eave part (27), and a principal surface (21) in the third region (A3). The conductor layer (5) is stacked on the dielectric layer (4). The first porous part (23A) has a plurality of a first micropores (24) running in a thickness direction (D1) defined with respect to the silicon substrate (2). In the first porous part (23A), each pair of first micropores (24) located adjacent to each other which belong to the plurality of first micropores (24) has a non-uniform interval (L1) in the thickness direction (D1) defined with respect to the silicon substrate (2). The second porous part (23B) has a plurality of second micropores (25). An interval between each of the plurality of second micropores (25) and the eave part (27) as measured in the thickness direction (D1) defined with respect to the silicon substrate (2) increases its length as a distance from the first region (A1) increases and a distance to the third region (A3) decreases. The capacitor (1; 1A) meets, with respect to the eave part (27), at least one of a first condition or a second condition. The first condition is a condition that a first distance (H1) that is the shortest distance between a plane (VP1) including a principal surface (21) in the third region (A3) and the first porous part (23A) as measured in the thickness direction (D1) defined with respect to the silicon substrate (2) should be longer than a second distance (H2) between the plane (VP1) and a surface (27B), facing the second porous part (23B), of the eave part (27) as measured in the thickness direction (D1) defined with respect to the silicon substrate (2). The second condition is a condition that a tip (272) of the eave part (27) should be located outside of an inner peripheral edge of the second region (A2) when viewed in plan.

This aspect allows for increasing the capacitance.

In a capacitor (1; 1A) according to a second aspect, which may be implemented in conjunction with the first aspect, the conductor layer (5) includes a first conducive part (51), a second conducive part (52), a third conducive part (53), and a fourth conducive part (54). The first conducive part (51) covers the surface (231A) of the first porous part (23A). The second conducive part (52) covers the surface (231B) of the second porous part (23B). The third conducive part (53) covers the principal surface (21) in the third region (A3). The fourth conducive part (54) covers the eave part (27). In the conductor layer (5), the fourth conducive part (54) is connected to at least one of the first conducive part (51) or the second conducive part (52) in at least a part of an inner peripheral edge (541) of the fourth conducive part (54).

This aspect may reduce the resistance of the conductor layer (5) more significantly, and therefore, allows for improving the characteristics of the capacitor (1; 1A).

In a capacitor (1; 1A) according to a third aspect, which may be implemented in conjunction with the second aspect, the fourth conducive part (54) is connected to at least one of the first conducive part (51) or the second conducive part (52) over an entire inner peripheral edge of the fourth conducive part (54) in the conductor layer (5).

This aspect may reduce the resistance of the conductor layer (5) more significantly, and therefore, allows for improving the characteristics of the capacitor (1; 1A).

In a capacitor (1; 1A) according to a fourth aspect, which may be implemented in conjunction with any one of the first to third aspects, a distance between the tip (272) of the eave part (27) and the second porous part (23B) as measured in the thickness direction (D1) defined with respect to the silicon substrate (2) is shorter than a distance between a proximal end (271) of the eave part (27) and the second porous part (23B) as measured in the thickness direction (D1) defined with respect to the silicon substrate (2).

This aspect makes it easier to form a conductor layer (5) in which the fourth conducive part (54) is connected to at least one of the first conducive part (51) or the second conducive part (52) in at least at a part of the inner peripheral edge of the fourth conducive part (54).

A capacitor (1; 1A) according to a fifth aspect, which may be implemented in conjunction with any one of the first to fourth aspects, meets both the first condition and the second condition.

This aspect allows for further increasing the capacitance.

In a capacitor (1; 1A) according to a sixth aspect, which may be implemented in conjunction with any one of the first to fifth aspects, the first distance (H1) is equal to or greater than twice, and equal to or less than ten times, as thick as the eave part (27).

In a capacitor (1; 1A) according to a seventh aspect, which may be implemented in conjunction with any one of the first to sixth aspects, the silicon substrate (2) has a doped layer (3) that contains either a p-type dopant or an n-type dopant. The doped layer (3) is formed to have a shape conforming to respective shapes of the first porous part (23A), the second porous part (23B), the eave part (27), and the principal surface (21) in the third region (A3).

This aspect makes it easier to increase the surface area of the surface (231A) of the first porous part (23A) and the surface area of the surface (231B) of the second porous part (23B).

In a capacitor (1; 1A) according to an eighth aspect, which may be implemented in conjunction with the seventh aspect, when the doped layer (3) contains the p-type dopant, the p-type dopant is either boron or indium, and when the doped layer (3) contains the n-type dopant, the n-type dopant is phosphorus, arsenic, or antimony.

### REFERENCE SIGNS LIST

1,1A Capacitor
2 Silicon Substrate
21 First Principal Surface
22 Second Principal Surface
23A First Porous Part
231A Surface
23B Second Porous Part
231B Surface
24 First Micropore
25 Second Micropore
27 Eave Part
27B Surface
270 Surface
271 Proximal End
272 Tip
3 Doped Layer
4 Dielectric Layer
5 Conductor Layer
7 First External Connection Electrode
8 Second External Connection Electrode
A1 First Region
A2 Second Region
A3 Third Region
D1 Thickness Direction
H1 First Distance
H2 Second Distance
L1 Interval
VP1 Plane

1. A capacitor comprising:
a silicon substrate having: a first region in which a first porous part is formed; a second region in which a second porous part is formed and which surrounds the first region; a third region which surrounds the second region; and an eave part which protrudes inward from the third region and overlaps with the second porous part when viewed in plan;
a dielectric layer arranged to cover, in the silicon substrate, a surface of the first porous part, a surface of the second porous part, a surface of the eave part, and a principal surface in the third region; and
a conductor layer stacked on the dielectric layer,
the first porous part having a plurality of a first micropores running in a thickness direction defined with respect to the silicon substrate,
each pair of first micropores located adjacent to each other which belong to the plurality of first micropores in the first porous part having a non-uniform interval in the thickness direction defined with respect to the silicon substrate,
the second porous part having a plurality of second micropores,
an interval between each of the plurality of second micropores and the eave part as measured in the thickness direction defined with respect to the silicon substrate increasing its length as a distance from the first region increases and a distance to the third region decreases, and
the capacitor meeting, with respect to the eave part, at least one of a first condition or a second condition,
the first condition being a condition that a first distance that is a shortest distance between a plane including a principal surface in the third region and the first porous part as measured in the thickness direction defined with respect to the silicon substrate be longer than a second distance between the plane and a surface, facing the second porous part, of the eave part as measured in the thickness direction defined with respect to the silicon substrate,
the second condition being a condition that a tip of the eave part be located outside of an inner peripheral edge of the second region when viewed in the plan.

2. The capacitor of claim 1, wherein
the conductor layer includes
a first conducive part that covers the surface of the first porous part,
a second conducive part that covers the surface of the second porous part,
a third conducive part that covers the principal surface in the third region, and
a fourth conducive part that covers the eave part, and
in the conductor layer, the fourth conducive part is connected to at least one of the first conducive part or the second conducive part in at least a part of the inner peripheral edge of the fourth conducive part.

3. The capacitor of claim 2, wherein
in the conductor layer, the fourth conducive part is connected to at least one of the first conducive part or the second conducive part over an entire inner peripheral edge of the fourth conducive part.

4. The capacitor of claim 1, wherein
a distance between the tip of the eave part and the second porous part as measured in the thickness direction defined with respect to the silicon substrate is shorter than a distance between a proximal end of the eave part and the second porous part as measured in the thickness direction defined with respect to the silicon substrate.

5. The capacitor of claim 1, wherein
the capacitor meets both the first condition and the second condition.

6. The capacitor of claim 1, wherein
the first distance is equal to or greater than twice, and equal to or less than ten times, as thick as the eave part.

7. The capacitor of claim 1, wherein
the silicon substrate has a doped layer that contains either a p-type dopant or an n-type dopant, and
the doped layer is formed to have a shape conforming to respective shapes of the first porous part, the second porous part, the eave part, and the principal surface in the third region.

8. The capacitor of claim 7, wherein
when the doped layer contains the p-type dopant, the p-type dopant is either boron or indium, and
when the doped layer contains the n-type dopant, the n-type dopant is phosphorus, arsenic, or antimony.
